(19) United States
(12) Patent Application Publication
(10) Pub. No.: US 2017/0069108 A1
(43) Pub. Date: Mar. 9, 2017

(54) OPTIMAL 3D DEPTH SCANNING AND POST PROCESSING

(71) Applicant: Sungwook Su, Torrance, CA (US)

(72) Inventor: Sungwook Su, Torrance, CA (US)

(21) Appl. No.: 15/259,900

(22) Filed: Sep. 8, 2016

Related U.S. Application Data
(63) Continuation-in-part of application No. 15/135,536, filed on Apr. 21, 2016.
(60) Provisional application No. 62/216,916, filed on Sep. 10, 2015.
(60) Provisional application No. 62/151,897, filed on Apr. 23, 2015.

(51) Int. Cl. G06T 7/20; H04N 13/02; G06T 17/10; G06T 7/00

(52) U.S. Cl. CPC G06T 7/2093; G06T 7/0075; H04N 13/0239; G06T 17/10

(57) ABSTRACT

Some embodiments provide a method of capturing data relating to objects in a scene. The method of some embodiments uses a set of one or more depth sensors to capture data relating to the object. In some embodiments, the method uses one dynamic range-adjusting depth sensor to capture the same target with different resolutions. Alternatively, in some embodiments, the method uses multiple depth sensors. While capturing a target object, the method of some embodiments tracks the current position and the target surface, in order to provide seamless 3D data relating to the object.

### CLAIM OF BENEFIT TO PRIOR APPLICATIONS

This application claims the benefit of U.S. Provisional Patent Application 62/216,916, filed on Sep. 10, 2015. This application is also a continuation in part of U.S. Non-Provisional application Ser. No. 15/135,536, filed Apr. 23, 2016. U.S. Non-Provisional application Ser. No. 15/135,536 claims the benefit of U.S. Provisional Patent Application 62/151,897, filed on Apr. 23, 2015. U.S. Provisional Patent Applications 62/151,897 and 62/216,916, and U.S. Non-Provisional application Ser. No. 15/135,536 are incorporated herein by reference.

### BACKGROUND

When a depth sensor is used to capture a video or a still shot, it detects the geometric distances and the sizes different objects in a scene using dynamic scanning range of depth. Today, such a depth sensor is widely used in tracking the motion of an object.

### BRIEF SUMMARY

Embodiments described herein provide a method of capturing data relating to objects in a scene. The method of some embodiments uses a set of one or more depth sensors to capture data relating to the object. In some embodiments, the method captures data in far distance first, and then, it captures data in closer ranges to add more details. The process can be done in the reverse order as well. That is, the method can capture data in near distance first, and then capture additional data at one or more nearer distances thereafter.

In some embodiments, the method uses one dynamic range-adjusting depth sensor to capture the same target with different resolutions. Alternatively, in some embodiments, the method uses multiple depth sensors. The multiple depth sensors may be set to capture different distance ranges or set to capture data with different zoom lens. The method of some embodiments simultaneously or concurrently captures multiple different resolutions depth data of the same target object using several depth sensors.

While capturing a target object, the method of some embodiments tracks the current position and the target surface. The method performs the tracking in order to make or provide seamless data relating to the object. For instance, the method may maintain position and target surface data in order to add additional details to a selected area of the object. In some embodiments, the different resolution data are combined together, based on the tracked current position and target surface data, in order to add more detail to a selected area. For instance, if the target object is a person, a 3D model of the person can be constructed by providing low level of detail on one area (e.g., the body of the person) and proving high level of detain on one or more other area (e.g., the face of the person, the hands, etc.).

In some embodiments, the method captures depth data or depth data set. A depth data set may be a depth map. In some such embodiments, the method captures, in a far distance, a low resolution depth map of a target object in a scene. The method then captures, in a close distance, a high resolution depth map of the target object. The method may capture one or more additional depth maps with different resolution data. For instance, the method may capture, in a mid distance, a mid resolution depth map of the same target object.

In some embodiments, the method produces a 3D model of the object in the scene using the low and high resolution depth maps. Alternatively, the method sends data, which are based on the low and high resolution depth maps, over a network to a computing device (e.g., a server computer). The computing device then produces a 3D model of the object in the scene using the received data.

In conjunction with producing a 3D model or instead of it, the method of some embodiments searches a data store to identify the object from a number of different objects. As an example, the method may derive data values based on the low and high resolution depth maps. The method may then search a database to find the object using the data values.

In some embodiments, the method dynamically changes the depth sensor range from far distance to close distance when capturing the low and high resolution depth maps. This can be done in the reverse order as well. In some embodiments, the method utilizes multiple sensors that are tuned or set to scan a scene with different distance ranges.

In some embodiments, the method directs a set of one or more depth sensors to capture different resolution depth data from a single perspective. For instance, the set of depth sensors may capture the low and high resolution depth maps from one angle of view. Alternatively, in some embodiments, the method directs the set of depth sensors to capture different resolution depth data from multiple different perspectives. For instance, the set of sensors may captures different resolutions of details on selected surface areas of the object from multiple different angles. To handle different resolution data from different perspectives, the method of some embodiments tracks the current position and target surface. As indicated above, the tracking also allows the method to add more or less details on a selected surface area of a target object.

In additional to capturing depth maps, the method of some embodiments captures photos. In some embodiments, the method associates each photo with a depth map. This is because the photo contains data relating to the same view as the depth map. For instance, the depth map has depth data or distance data relating to a scene, and the photo has color data relating to the same scene. In taking photos, the method of some embodiments captures, in one distance range (e.g., in a far distance, or in a zoomed out mode for a long or medium shot), a first photo showing the object in the scene along with the low resolution depth map. The method of some embodiments then captures, in another distance range (e.g., in a near distance or in a zoomed in mode for a close-up shot), a second photo that shows a close-up of the object shown in the first photo. The photos and the depth maps may be captured in one burst mode 3D capture operation.

Embodiments described herein also provide a computing device. The computing device has or is associated with several depth sensors set to different distances or with different zoom lens. The multiple depths sensors are for capturing depth data relating a same target object with different resolutions. The computing device also has a set of processors to process the captured depth data and a set of storages to store the captured depth data. In some embodiments, the computing device has multiple depth sensors that simultaneously or concurrently capture the same target of object at the different resolutions.

Embodiments described herein also provide a non-transitory machine readable medium storing a program for execution by at least one processing unit. The program receives different resolution depth data relating to a target object. The program then builds a 3D model with different resolution of details on different areas based on the different resolution depth data.

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually shows a system that uses a range-adjusting depth sensor to capture different resolution 3D data.

FIG. 2 shows an example of a depth sensor that dynamically adjusts its scanning range to capture data.

FIG. 3 conceptually illustrates a process that some embodiments perform to dynamically capture 3D data relating to a scene.

FIG. 4 conceptually shows a system that captures different resolution 3D data using multiple depth sensors.

FIG. 5 conceptually shows another system that captures different resolution 3D data using multiple depth sensors.

FIG. 6 shows capturing data from different perspective using multiple depth sensors.

FIG. 7 shows capturing data from different perspective using a single depth sensor.

FIG. 8 illustrates two example ranges images captured with a depth sensor.

FIG. 9 conceptually shows an example system that creates a 3D model of an object from captured data.

FIG. 10 conceptually illustrates a process that some embodiments perform to create a 3D model.

FIG. 11 shows an example of compressing a captured object.

FIG. 12 shows a system that uses a base model to recreate an object.

FIG. 13 conceptually illustrates a program that extracts and retains several maps when dynamically generating a new 3D model.

FIG. 14 conceptually illustrates an example process that some embodiments perform to create a 3D model of an object.

FIG. 15 shows a part of a facial identification system according to some embodiments of the invention.

FIG. 16 shows the reaming part of the facial identification system of FIG. 15.

FIG. 17 conceptually illustrates a computer system with which some embodiments of the invention are implemented.

FIG. 18 conceptually illustrates a mobile device with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method of capturing data relating to objects in a scene. The method of some embodiments uses one or more depth sensors and captures data in far distance first, and then, it captures data in closer ranges to add more details. The process can be done in the reverse order as well. That is, the method may capture data in a near distance first, and then capture additional data at one or more nearer distances thereafter.

The processed data can be used to produce a 3D model that has a more detailed and precise description than 2D photos or videos. In some embodiments, the data can be transferred and viewed in any angle and can be easily zoomed in/out with capable mobile devices. The method of some embodiments compresses large raw data into a fraction of its original raw size. This allows data to be transferred quickly over a network.

As indicated above, when a depth sensor is used to capture a video or a still shot, it detects the geometric distances and size of objects using dynamic scanning range of depth. This makes the captured RAW data optimal and ideal to derive 3D data regarding the object. In some embodiments, the method uses a single or array of depth sensors that work like a telescope. That is, the method uses one or more depth sensors to capture RAW data relating to the object and derive 3D data from the RAW captured data.

Most of currently available depth sensors have a fixed scan range. As an example, Kinect® by Microsoft has a single depth sensor that is tuned to scan within 1 to 3 meter range. Accordingly, the method of some embodiments is performed by a computing device that is associated with at least one depth sensor that can dynamically adjust the scan distance range. Alternatively, in some embodiments, the method uses multiple depth sensors that are set to scan at different scan ranges.

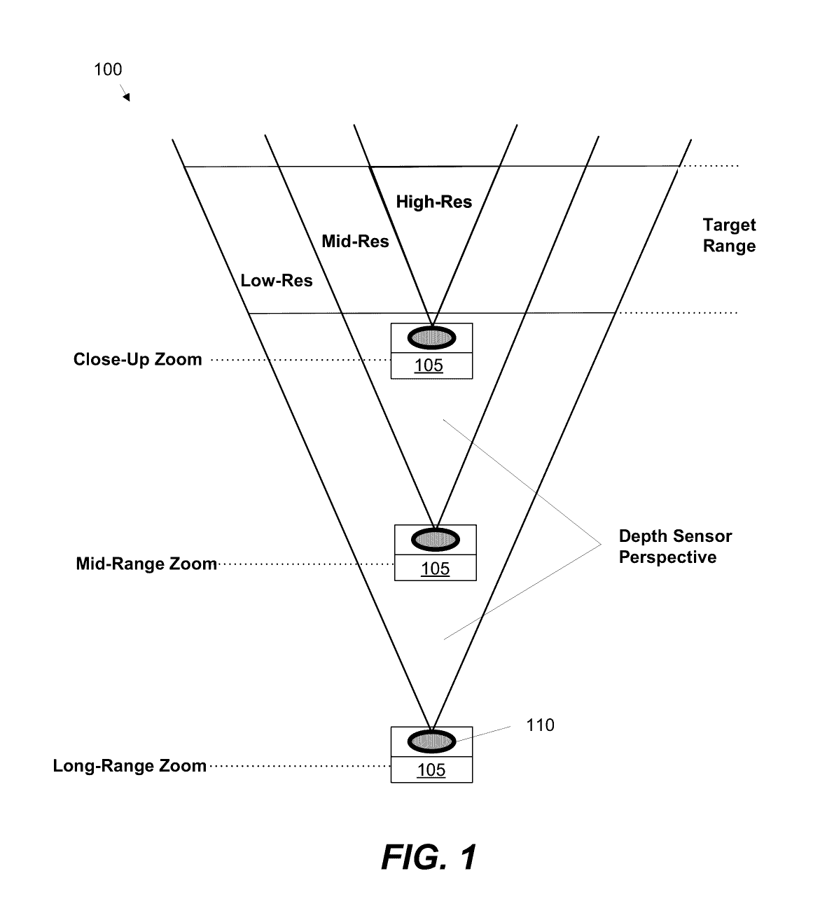

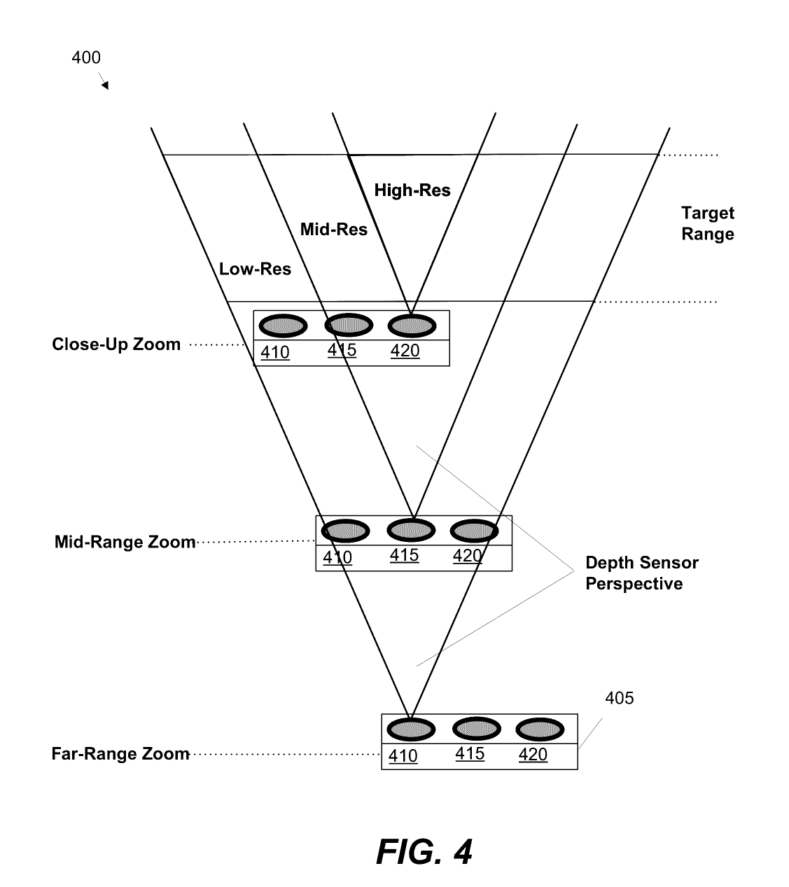

For some embodiments of the invention, FIG. 1 conceptually shows a system 100 that uses a range-adjusting depth sensor 110 to capture different resolution 3D data. An example of another system that utilizes multiple depth sensors to capture 3D data will be described below by reference to FIG. 4.

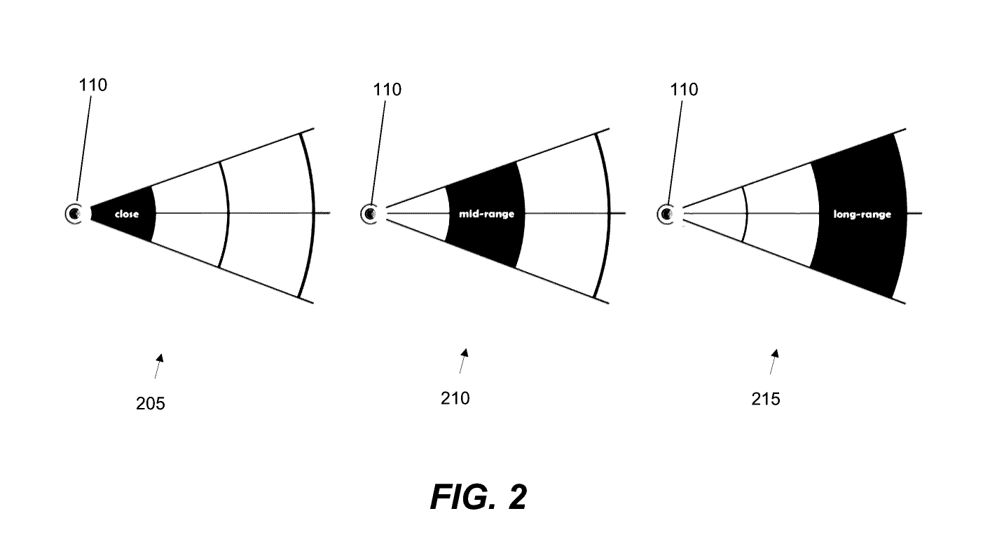

FIG. 1 will now be described by reference to FIG. 2. FIG. 2 shows an example of a depth sensor that dynamically adjusts its scanning range to capture data. To make the description clearer, the word “data” may also be referred to herein as “data set” or “dataset”.

As shown in FIG. 1, the system 100 has an electronic device 105 with a range-adjusting depth sensor 110. The device 105 can be one of many different types of devices. In some embodiments, the device 105 is a computing device. Examples of different types of computing devices include a computer, gaming system, digital camera, smart phone, digital media receiver, and tablet.

In some embodiments, the electronic device 105 is an input device to a computing device. That is, the electronic device 105 can be one that is communicatively or physically coupled to another electronic device. For instance, the device 105 can be an input device to a computer or a gaming system. The input device can also be a game controller.

The depth sensor 110 can estimate how far things are away from it. In some embodiments, the depth sensor 110 has a set of one or more components to estimate the distances of the different objects in a scene.

In some embodiments, the depth sensor 110 has a number of different components. The depth sensor 110 may have a set of one or more cameras. This is to take photos of a scene. The depth sensor 110 may also have a set of infrared laser projectors. A laser projector emits laser beams. The data gathered with the beams may be combined with the camera distance data to triangulate the distances of the different objects. In some embodiments, the depth sensor 110 has a number of lenses to perform the various different zooming operations.

Different from a typical depth sensor, the range-adjusting depth sensor 110 can dynamically adjusts its scanning range from one set range to another. For instance, the adjustable depth sensor 110 can be instructed to scan within one distance range first using one lens, then switch to another different distance range using a different lens, and so forth.

In some embodiments, the range adjusting depth sensor 110 is controlled by a device driver. For instance, a user may instruct a program or operating system (OS) to capture 3D data. The program of the OS may then communicate with the device driver to capture distance data with the depth sensor.

In some embodiments, the range-adjusting adjusting depth sensor 110 uses one or more different means to scan different resolution data. This can be achieved optically or digitally. For instance, the depth sensor 110 can use optical zoom with physical camera lens to zoom in and out of an area. Alternatively, the device can use digital processing program or filter to perform the zooming operations.

Having described several components, the operations of the system 100 will now be described. As shown in FIG. 1, the device 105 captures multiple different resolution data sets relating to one or more objects that are within a target range. In this example, the device 105 captures low, mid, and high resolution data sets. The low-resolution data (e.g., image) captures any objects that are within the target range. The mid-resolution data captures some portion of the scene depicted in the low-resolution data. For instance, the mid-resolution image may have a shot that is narrower than the one shown in the low-resolution image. Finally, the high resolution data has a shot that features a close-up of some area within the target range.

FIG. 2 shows an example of how the depth sensor 110 of some embodiments captures data during one 3D capture operation. Three stages 205-215 of operations of the depth sensor 110 are shown in the figure. Specifically, these stages show the depth sensor 110 capturing data from multiple different scanning ranges.

The first stage 205 shows that, in one 3D capture operation, the dept sensor 110 may first capture a close-up image. The second stage 210 shows that the depth sensor 110 may then capture a mid-range image. Finally, the third stage 215 shows that the depth sensor 110 may then capture a long-range image.

In the example of FIG. 2, the depth sensor 110 shoots data staring from closest distance range first and then proceeding to any necessary farther ranges next. In some embodiments, the depth sensor 110 shoots in the reverse order. That is, the depth sensor shoots starting with the farthest distance range first and then proceeding to any necessary nearest ranges next.

The sensors that are available today have very limited fixed scan ranges. So, they cannot capture data that are out of range. However, the method of some embodiments utilizes a depth sensor that can dynamically change the range to capture the different level of detail.

As will be elaborated below, the method of some embodiments also assembles arrays of input data. If the user uses multiple sensors together, the method can combine different ranges of data to make one multi-sampled wide range data. Alternatively, the method can also build a data with multiple resolutions on it.

Further, different embodiments can capture different number of 3D data sets. The number of images that the depth sensor 110 captures during one capture session may be different. FIG. 2 conceptually shows three depth images being generated. However, the depth sensor 110 may capture more images or even or even fewer images. Also, the number of images that the depth sensor 110 captures per given range can change from implementation to implementation. For instance, the depth sensor 110 of some embodiments captures, for a given distance range, one or more photos (e.g., color, and/or black and white photo) along with one or more of depth images (e.g., depth maps).

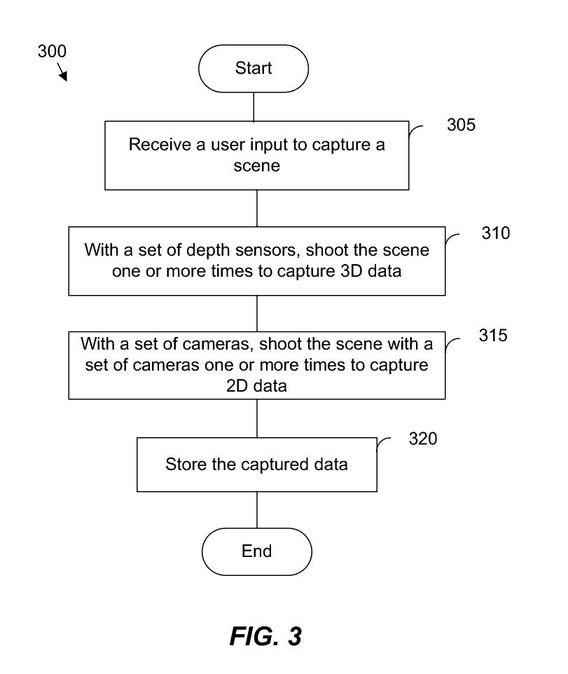

Having described several example operations, an example process will now be described. FIG. 3 conceptually illustrates a process 300 that some embodiments perform to dynamically capture 3D data relating to a scene. In some embodiments, the process 300 is performed by an electronic device. The electronic device may run one more programs to perform the operations listed in the figure.

As shown, the process 300 begins by receiving (at 305) a user input to capture a scene. Different embodiments can receive this input differently. For instance, the user might click on a capture button or a photo taking button to make the input. Alternatively, the user might click on an input item or device, such as a touch-screen, mouse, keyboard, game pad, etc.

At 310, the process 300 shoots the scene with the depth sensor one or more times to capture 3D data. The process then shoots (at 315) the scene with a camera to capture 2D data. For instance, the process 300 might capture a color, grayscale, and/or black and white photo with the camera. Each photo may show the same scene or portion of the scene as one depth image. In some embodiments, the method maintains, for each depth map image, at least one matching photo.

As shown in FIG. 1, the process 300 of some embodiments stores (at 320) the captures data. The process 300 then ends.

Some embodiments perform variations on the process 300. The specific operations of the process 300 may not be performed in the exact order shown and described. The specific operations may not be performed in one continuous series of operations, and different specific operations may be performed in different embodiments.

Several addition examples of capturing and using 3D data are described below. Specifically, Section I describes several example capturing operations. Section II then descries several examples of recreating objects. This is followed by Section III, which describes an example facial identification system. Lastly, Section IV describes several electronic systems for implementing some embodiments of the invention.

### I. Example Capturing Operations

In some embodiments, the method performs a number of operations to capture data relating to a target object. Several such examples will now be described by reference to FIGS. 4-8.

A. Using a Plurality of Depth Sensors

In several of the examples described above, the system uses one dynamic range adjusting depth sensor to capture data at different distance ranges. Instead of only one depth sensor, the system of some embodiments uses several depth sensors to perform the capturing operations.

FIG. 4 conceptually shows a system 400 that captures different resolution 3D data using multiple depth sensors. This figure is identical to FIG. 1. However, in FIG. 4, the device 405 has three depth sensors 410-420. The depth sensor 420 captures the high-resolution data. The depth sensor 415 captures the mid-resolution data. Finally, the depth sensor 410 captures the low-resolution data. Each of the depth sensors 410-420 may use a different camera lens to capture data at different zoom level.

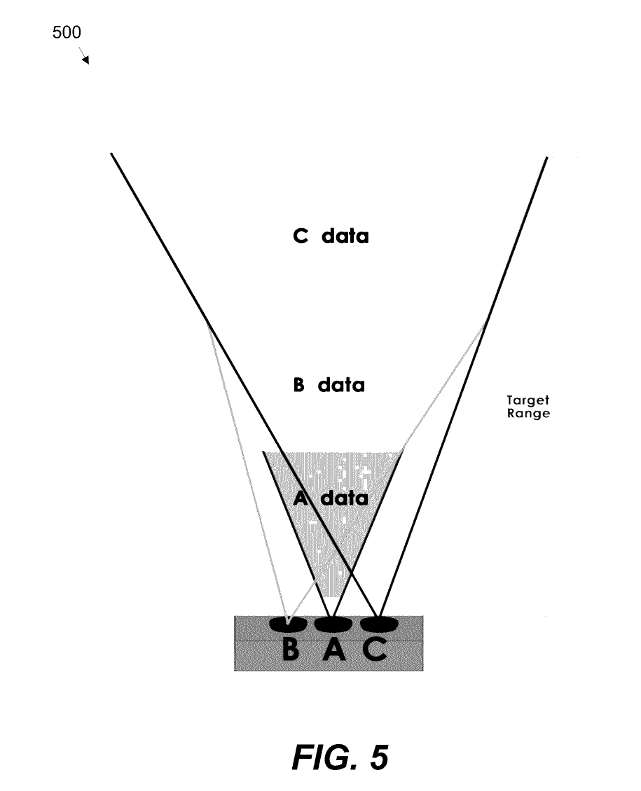

FIG. 5 conceptually shows another system 500 that captures different resolution 3D data using multiple depth sensors. FIG. 5 shows three sensors (labeled A-C) capturing three different ranges and the details of the data, and combining together the different range data to make one big range of data.

B. Capturing Data from Different Angles

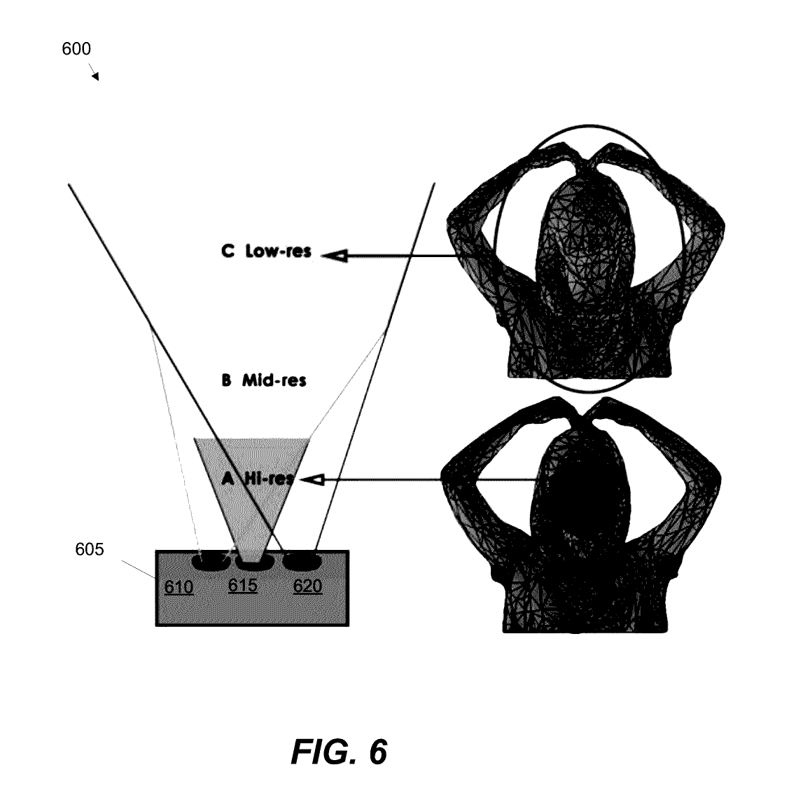

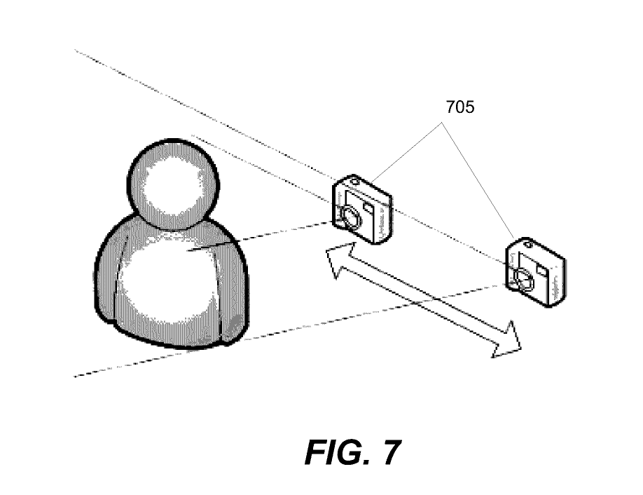

As shown by the dashed arrow of FIG. 4, the method of some embodiments shoots multiple shots (e.g., photos, videos) of a scene from a single depth sensor perspective. In some embodiments, the method shoots multiple shots from different angles or perspectives. Several such examples will now be described below by reference to FIGS. 6 and 7. Specifically, these figure show dynamically capturing one target object by changing the distance range of the sensor(s) in order to capture detail regarding a selected area.

FIG. 6 shows an example system that captures data from different perspective using multiple depth sensors. As shown, the device 605 has three depth sensors 610-620. The third depth sensor 620 is used to capture a wide shot of the person (e.g., with the body). The device also uses the second depth sensor 615 to capture a close-up of the face of the person. The close-up contains data high-resolution data.

FIG. 7 shows capturing data from different perspective using a single depth sensor. This is conceptually shown with one digital camera 705 taking multiple shots of the same person. Similar to the example of FIG. 6, the person is shot from multiple different angles to capture the 3D data.

In some embodiments, the method uses dynamic 3D resolution building scheme or algorithm. The method may perform these operation based on a measured distance or by zoom lens to capture data. In some embodiments, the method uses optical means or digital means to capture different resolution data. Using this method, a system device can capture different resolutions of details on a selected area to add more or less details.

While capturing RAW data with a portable device, the method of some embodiments constantly stack depth data into 3D space. The portable device has gyro sensors and position tracking system in order to identify its own position and rotation. If the sensor gets close-up data then it subdivides the 3D grid to store more detailed data on certain area like the face.

C. Captured Range Image

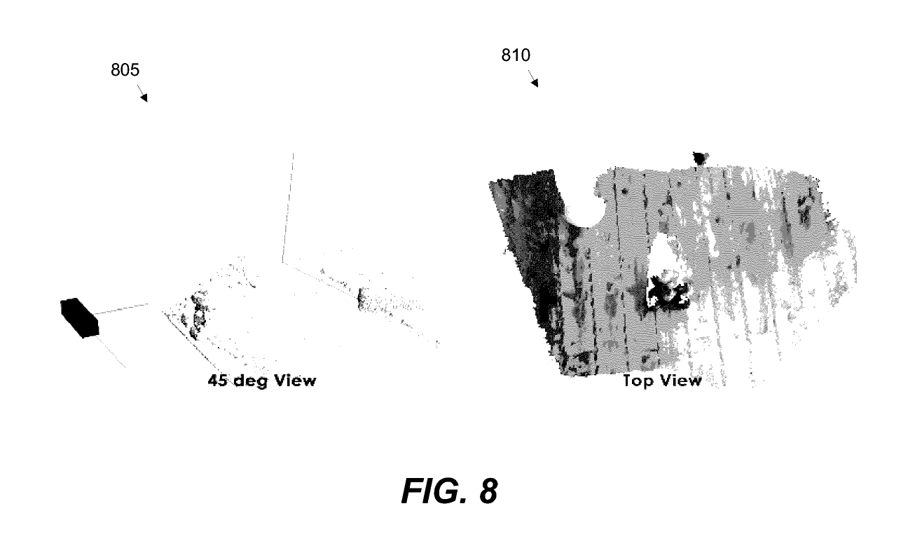

In some embodiments, the depth sensor 110 captures a range image. FIG. 8 illustrates two example ranges images 805 and 810 captured with a depth sensor. Specifically, the image 805 shows distance data of a scene from 45° . The image 810 shows the distance of a scene form a top view. Each range image (805 or 810) has pixel values that indicate the distances of the objects. Here, the image's lighter color may indicate a closer distance, while the image's darker color may indicate a farther distance.

In some embodiments, the range image is a depth map. The depth map can be an image file or channel comprising data associated with the distances of the surfaces of different objects in a scene from a viewpoint of a depth sensor.

### II. Example Recreating Operations

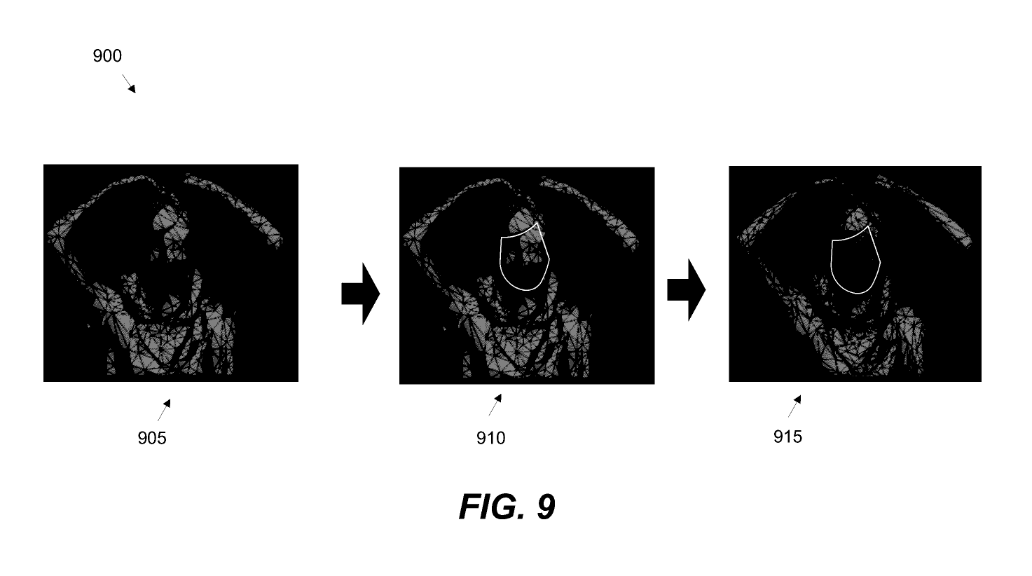

In some embodiments, the method performs a number of different operations to recreate an object. Several such example operations will now be described below by reference to FIGS. 9-14.

A. Overview

FIG. 9 conceptually shows an example system that creates a 3D model of an object from captured data. Three stages 905-915 of operation of the method of some embodiments are shown in the figure. In some embodiments, the method is performed by a program running on a computing device.

In some embodiments, the method first uses the low resolution data to constructs the object first. The method then adds any necessary details using one or more different higher resolution data. This is shown in the example of FIG. 9. Specifically, the first stage 905 shows the method loading a low resolution data set of a person's body. The second stage 910 shows the method selecting an area (e.g., of the person's face) to add more detail. This is shown with the white outline around the face of the low resolution 3D model. Finally, the third stage 915 shows the method replacing the low resolution face data with the high resolution face data.

As shown by the model on the far right of the third stage 915 of FIG. 9, the method can capture more details (e.g., higher resolution data) on a selected area, such as the face. A 2D image has a fixed resolution on each image, but 3D data can have variable amount of data on each area. By using one or more of the different scanning methods described above, the system's device can capture more details and store more accurate data on important areas like the face.

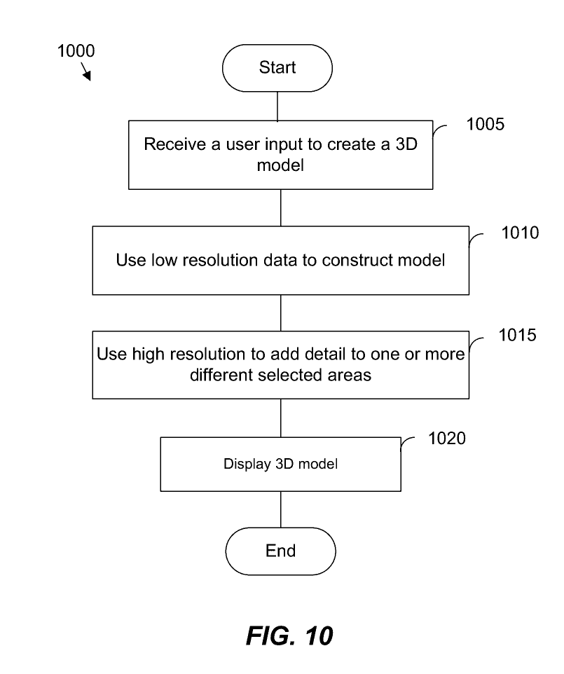

Having described an example of recreating an object, an example process will now be described. FIG. 10 conceptually illustrates a process 1000 that some embodiments perform to create a 3D model. In some embodiments, the process 1000 is performed by an electronic device. The electronic device may run one more programs to perform the operations listed in the figure.

As shown, the process 1000 begins by receiving (at 1005) a user input to create a 3D model. The process 1000 then uses (at 1010) the captured low resolution data to construct the model. The process 1000 then uses (at 1015) the captured high resolution data to add more detail different selected areas. The process 1000 then displays (at 1020) the 3D model. The process 1000 then ends.

Some embodiments perform variations on the process 1000. The specific operations of the process 1000 may not be performed in the exact order shown and described. The specific operations may not be performed in one continuous series of operations, and different specific operations may be performed in different embodiments.

B. Example Operations

In addition to combining different resolution data, the method of some embodiments performs several different operations to recreate an object from scanned data. Several such examples will now be described below by reference to FIGS. 9-14.

1. Compressing Data

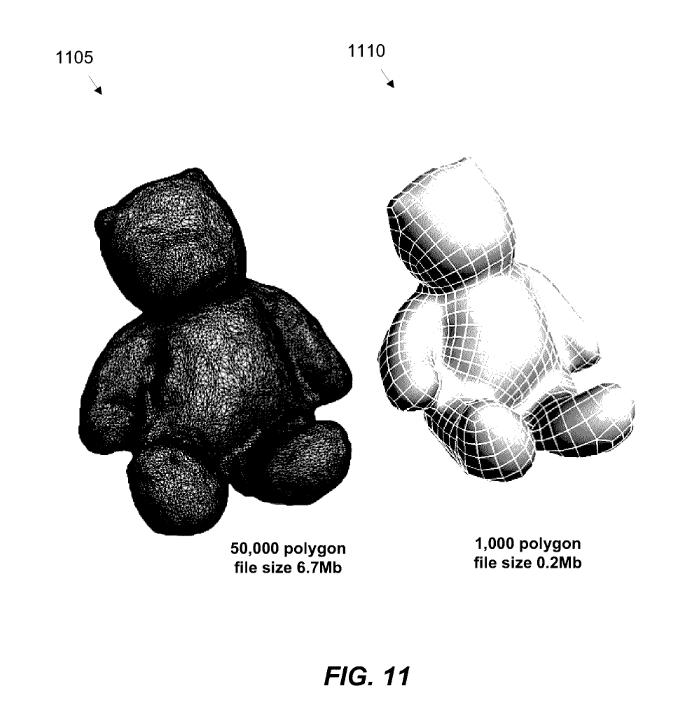

In some embodiments, the method takes raw scanned data of an object and compresses the data to a fraction of the size of the data. FIG. 11 shows an example of compressing a captured object. Specifically the figure shows a sample of an unknown target that the method of some embodiments rebuilt, from a 50,000 polygon RAW model 1105 to a 1,000 polygon model 1110.

In some embolisms, the captured data includes a number (e.g., millions) of vertex counts or point data. The data may also include one or more maps (e.g., images) that define the color, texture, the height (i.e., surface elevation), and/or the angular surface details of the object. For instance, the data may include a color map that defines the various colors of an object in the scene. Alternatively or conjunctive with the color map, the data may include a normal map, which is an image used to provide additional 3D detail to a surface by changing the shading of pixels so that the surface appears angular rather than completely flat. The normal map or some other map (e.g., a heightmap) can also be used to define height. Different embodiments can use different maps. For instance, the system may use a bump map to define the bumps on the surface of the object. To reiterate, the system may use one or more different maps that that define the color, texture, the height (i.e., surface elevation), and/or the angular details of the object.

Depending on the capture method, the captured data may include useless noise data. The captured data may include noise data or artifacts for several different reasons. As a first example, the object and/or the sensor may have been in motion when it was captured with a particular device. As a second example, the ambient light of the scene may have affected how the object was captured. As will be described in detail below, the reconstruction program of some embodiments automatically filters out the noise when generating a 3D model.

In the example of FIG. 11, the system loads the captured data of an object 1105. The captured data has a high poly count, namely 50,000. The file size of the captured data is shown as 6.7 megabytes (Mb). After loading, the system iterates through the captured data 1105 to generate a new model 1110. The new model has a fixed set of poly count, namely 1,000. The file size has also been reduced from 6.7 Mb to 0.2 Mb. In essence, the system has generated a compressed representation of the captured data. Despite the compression, the representation retains much of the shape or form (e.g., curvature) of the object specified in the captured data. To retain the shape, the system of some embodiments iterates through a non-uniform set of polygons to create an object that has a uniform set of polygons having a grid shape.

2. Deforming a Base Model

In some embodiments, the retargeting method involves deforming a base mesh (polygon) to fit this scanned volume data. In some embodiments the base model is a prepared mesh data that has pre-assigned values. The base model can have its own UV values. As will be elaborated below, the base model can make it much faster to recreate an object with detail than without it.

The base model of some embodiments is a template with pre-assigned values. Specifically, the base model template includes pre-assigned values relating to a specific type of object. The template may include a set of field values for each of the different features of the object. For instance, if the object is a human head, the base model template may have pre-defined values relating to facial features, such as the eyes, nose, mouth, etc. In some embodiments, the base model is a polygon mesh that is defined by vertices, edges, and faces. A vertex is a special type of point that describes a corner or intersection of a shape or object. An edge represents two vertices that are connected to one another. A face represents a set of edges that are joined together to form a surface.

There are several reasons why the program, in some embodiments, uses a base model when capturing an object. First, the program does not have to dynamically generate a new model. This can save time because, for certain objects, generating a new model is a processor and/or memory intensive task. The base model is associated with a uniform set of items that define the object. In some embodiments, the resulting model has the same vertex count and UV data (i.e., texture coordinates) as the original base model. The specific values may change from one resulting model to another. However, each resulting model is uniformly associated with the same number of data fields. The uniformity of the base model also allows the same type of object to be easily stored, cataloged, searched, and/or modified. In some embodiments, the base model is defined by a uniform set of polygons having a grid shape.

Second, the resulting model provides more detail in un-scanned areas. As an example, the captured data of a human head may not include data relating to specific areas such as inside the mouth, behind the ears, etc. In such areas, the program may use the base model's default values or modify those values to present the object. In other words, the program of some embodiments fills in the details that are not specified in the captured data. The end result is a 3D model that appears on screen with less visual artifacts than one with missing data.

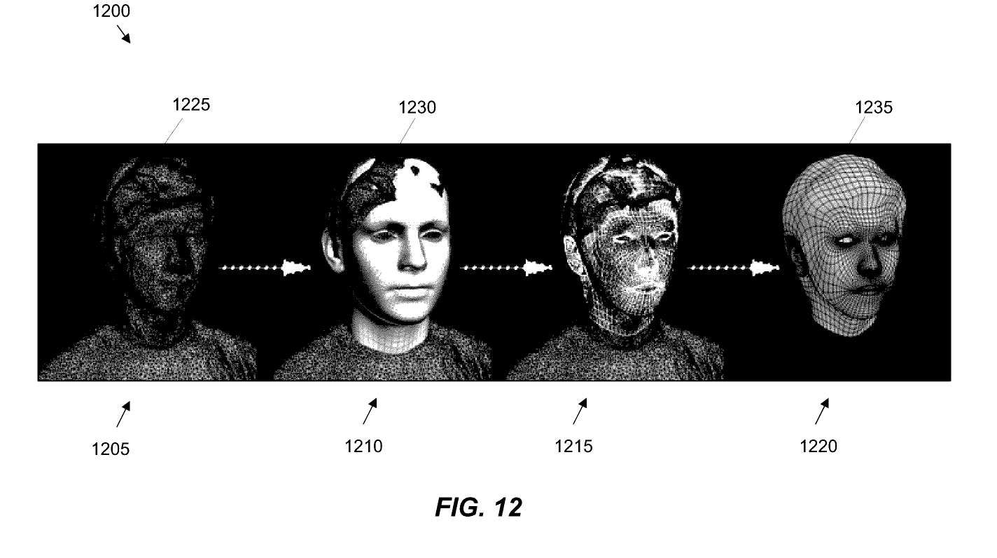

FIG. 12 shows a system 1200 that uses a base model 1230 to recreate an object 1235. The first stage 1205 shows that the program has received the captured data 1225. The captured data 1225 may have different resolution data relating to the object 1235.

In the second stage 1210, the system's program has analyzed the data 1225. The analysis has resulted in the program detecting a human head. Based on the result, the program has selected a base model 1230 for a human head.

The second stage 1210 also shows that the program takes the base model 1230 and deforms the model in accord with the captured data 1225. In particular, the program associates values in the captured data with that of the base model. Based on the association, the program then alters the base model so that the model's values reflect that of the captured data. In the example of the second stage 1210, the program alters the properties (e.g., vertices, edges, faces) of the polygon mesh. This is shown with raw data being applied to a portion of the forehead of the base mode.

The capture data may include a number (e.g., millions) of vertex counts or point data. In some embodiments, the program filters out the noise and uses filtered low polygonal template model (e.g., the base model 1230) to reduce the number of vertex counts and size, but not to reduce the level of detail. Each time the system transfers the captured data into template model, the program extracts or bakes out the surface height details into the normal map as a texture that contain displacement information. In some embodiments, the program extracts color and/or texture information relating to the different surfaces. So each time the system generates a 3D object, the program may compute or extract mesh data (e.g., vertices, edges, faces), and extract the color map and the normal map (e.g., heightmap) from the captured data.

In some embodiments, the program identifies a proper position on the model to apply the captured data. The program might use a 2D photo image that is taken together with depth data. The program then might (1) analyze the face in the photo, (2) identify properties of the face, (3) transfer those properties to 3D space, and (4) align transferred properties with those of the 3D model. As an example, once the program detects a known shape, the program associates pieces of data from the captured data set with that of the base model. The program moves the vertex into scanned data so that the resulting 3D model has the same volume and shape as the object in the scene. In moving, the program may adjust the vertices associated with the base model in accordance with the vertices associated with the object in the captured data.

In the third stage 1215 of FIG. 12 the program continues to apply the captured data 1225 to the base model 1230. The fourth stage 1220 shows the resulting 3D model 1235 that the program has generated from the captured data. The resulting 3D model retains much of the details of the target object. As indicated above, the captured data 1225 may include an abundance of point data (e.g., thousands or even millions of point data). Different from the captured data, the resulting 3D model 1235 has a uniform set of point data.

In some embodiments, the base mesh is a pre-treated polygonal mesh data that the system captures or builds. Once the system detects a known shape, it overlaps the data with our base model and then moves the vertices into scanned data to match the volume and shape. In some embodiments, method works on any object that it is able to recognize. For example, it could be a human organ with CT data instead of 3D volume scanned data. It will then search the database and compares regular patterns of organs. If there is a big difference, it will show us the results of how well the patterns and our object match respectively in both numerical and graphical representations.

In some embodiments, method reconstructs data, if the captured data is insufficient to build an entire object. The method can also reconstruct data the following two (2) methods. If the target object is symmetrical, it gets the missing data from the other side. Otherwise, if the target isn't symmetrical but the system knows what it is, missing data from the database is used to rebuild the object.

3. Extracting Various Maps

As mentioned above, the resulting model of some embodiments is associated with one or more maps or images that define the color, texture, the height (i.e., surface elevation), and/or the angular details of the object. In some embodiments, the system retains one or more of such maps in order to present the object.

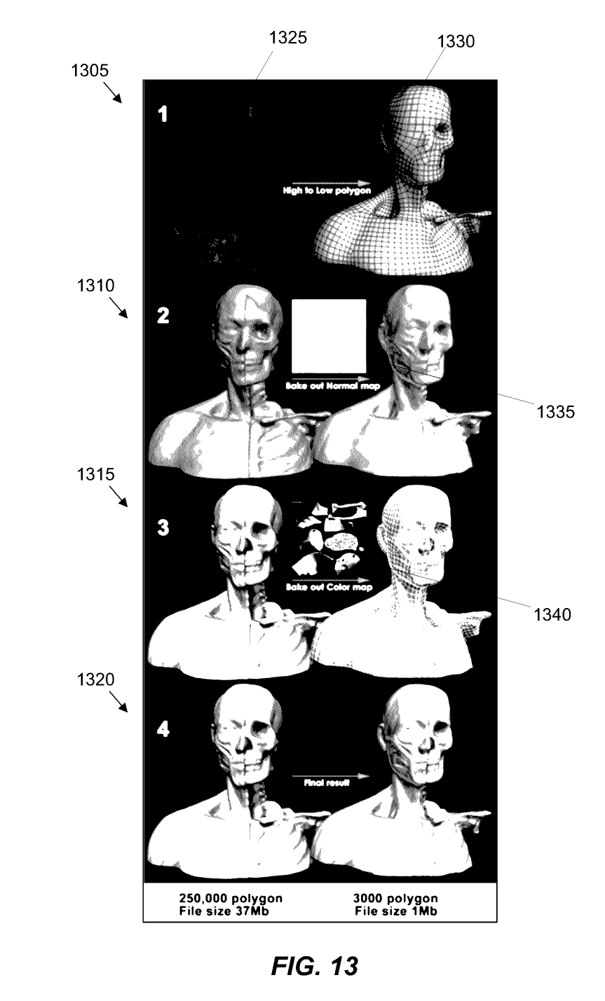

FIG. 13 conceptually illustrates a program that extracts and retains several maps when dynamically generating a new 3D model. Four operational stages 1305-1320 of the program are shown in the figure. The figure shows the captured object 1325 and the 3D model 1330.

In the first stage 1305, the program generates a low-poly model 1330 from a high-poly object 1325. As shown, the captured object 1325 has a high poly count, namely 250,000. The file size of the captured object is shown as 6.7 megabytes (Mb). By contrast, the new model 1330 has a fixed set of poly count, namely 3,000. The file size has also been reduced from 37 Mb to 1 Mb.

The second stage 1310 illustrates the program extracting a normal map 1335 from the captured object 1325. The second stage 1310 also shows how the new 3D model 1330 appears with the normal map in comparison to the captured object 1325. With the normal map, the 3D model 1330 appears with surface detail, which is different from the wire frame 3D model of the first stage 1310.

The third stage 1315 illustrates the program baking or extracting out a color map from the captured object 1325. The third stage 1315 also shows how the new 3D model 1330 appears with the color map in comparison to the captured object 1325. Lastly, the fourth stage 1320 shows how the resulting 3D model 1330 appears with all the maps in comparison to the captured object 1325. In particular, the fourth stage 1320 shows that the new 3D model 1330 appears with surface detail and color, and the model is nearly identical to the captured object 1325 despite its reduced number of polygons.

4. Deciding Whether to Use a Base Model or Generate a New Model

In some embodiments, the system uses a pre-defined base model to replicate an object or dynamically generates a new model. In some embodiments, if the scanned data appears close to a primitive or if the system knows the shape, it uses a base model to perform the retargeting operation. Otherwise, the system parametrically builds a new 3D model.

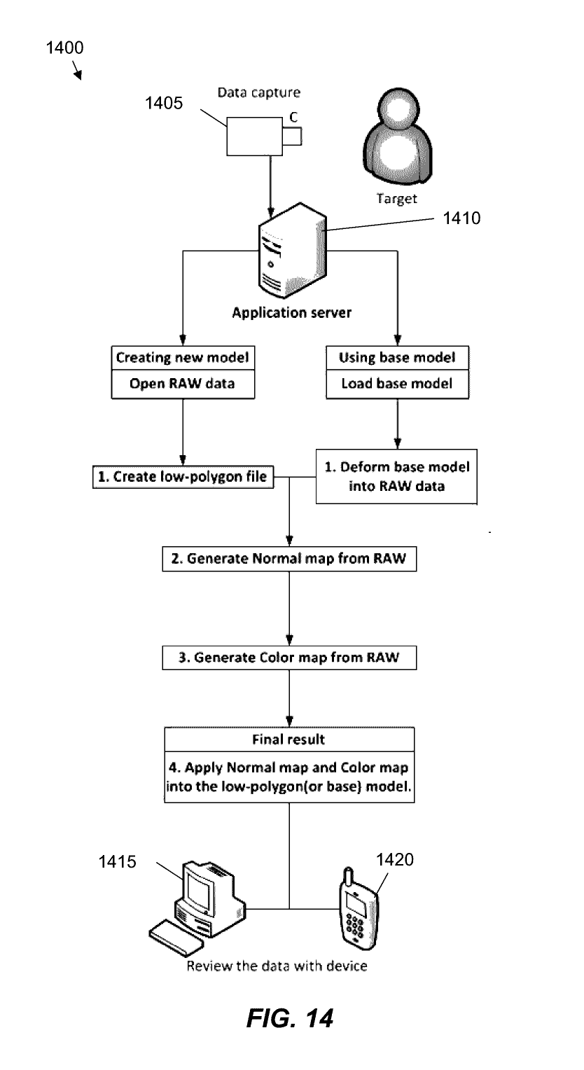

FIG. 14 conceptually illustrates an example process 1400 that some embodiments perform to create a 3D model of an object. In some embodiments, the process 1400 is performed by a reconstruction program that executes on a computing device.

As shown, the process 1400 begins by receiving (at 1405) scanned data of a scene that includes an object. The process 1400 then analyzes (at 1410) the data to detect the object in the scene. Based on the detected object, the process searches (at 1415) for a base poly model. For instance, the process might choose one specific base model from a number of different base models in accord with the detected object.

The process determines (at 1420) whether a match is found. If a match is found, the process 1400 deforms (at 1425) the base model to produce a representation of the object. However, if a match is not found, the process 1400 creates (at 1430) a new poly model based on the detected object.

As shown in FIG. 14, the process 1400 extracts (at 1435) a normal map from the scanned data. The process 1400 extracts (at 1440) a color map from the scanned data. Thereafter, the process 1400 associates the normal map and the color map to the deformed base model or the new poly model. In some embodiments, the process 1400 makes this association to define and store the new 3D model. The process 1400 might also apply (at 1445) the normal map and the color map to render and display the new 3D model. The process 1400 then ends.

Some embodiments perform variations on the process 1400. The specific operations of the process 1400 may not be performed in the exact order shown and described. The specific operations may not be performed in one continuous series of operations, and different specific operations may be performed in different embodiments.

### III. Example System

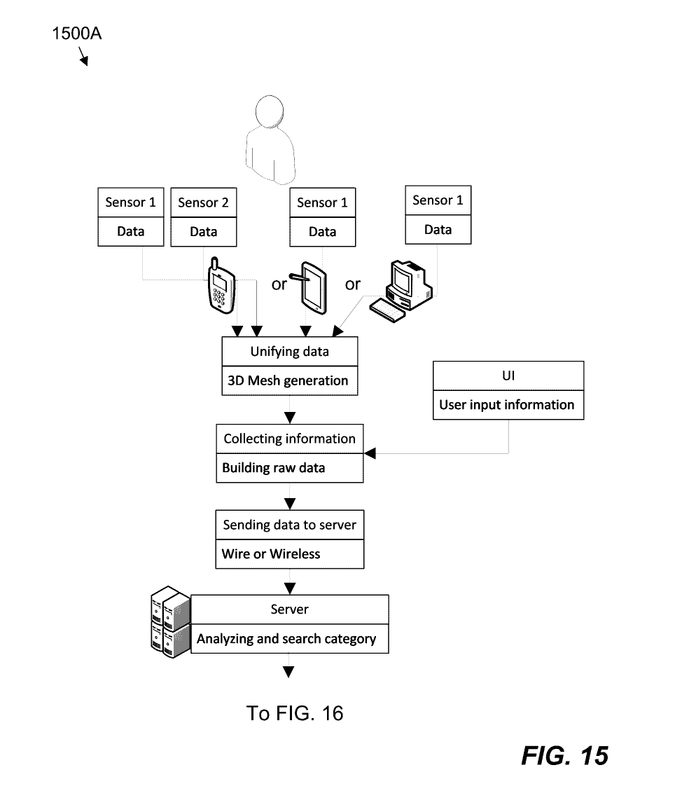

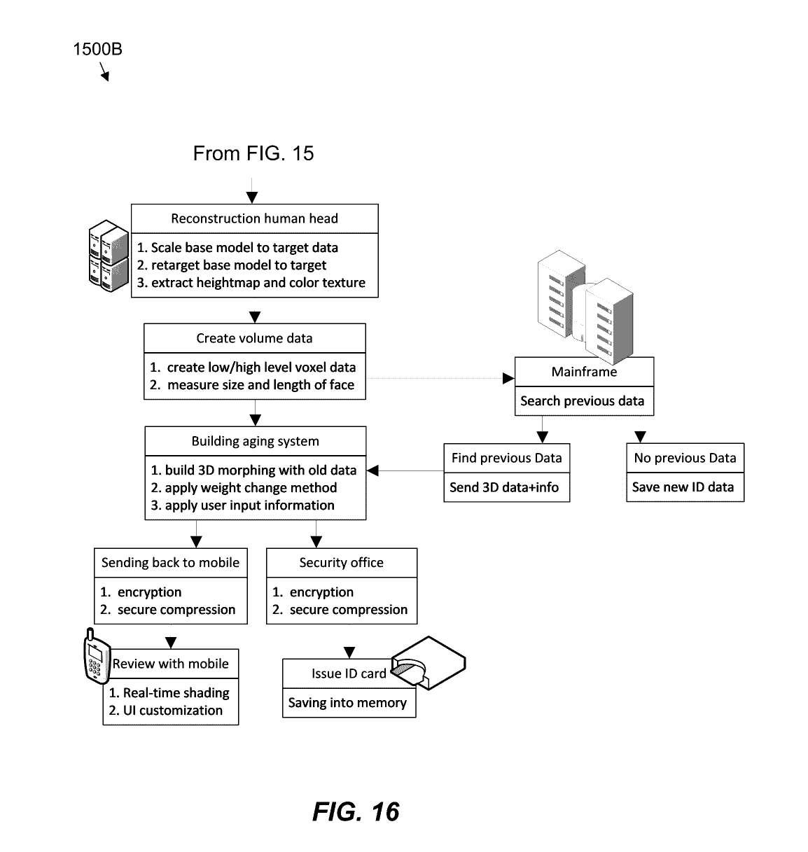

In some embodiments, the captured data is used for a 3D identification system. FIGS. 15 and 16 show an example system 1500 to use the captured 3D data to facial recognition and provide 3D models from captured data. As shown, the system includes a set of computing devices (e.g., mobile device, PDA, desktop computer), a set of server.

In some embodiments, each of these devices can capture data (e.g., build raw data with one or more depth sensors); generate 3D mesh data; and send data to a server in the set of servers.

FIG. 16 shows that each server in the set of servers can perform various task related to facial identification. For instance, the server analyzes and search different categories relating to a person. In some embodiments, the server has a set of programs to scale base model to target data, retarget base model to target, and extract heightmap and color texture.

In some embodiments, the set of servers create various different levels of voxel data. In some embodiments, the voxel data is volumetric data that is derived from the scanned data. In some embodiments, the voxel data is used for facial identification or person identification.

In some embodiments, the set of servers provides a 3D aging system. The 3D aging system can build 3D morphed data by combining different data, such as existing data with new data or forecast data. In some embodiments, the set of servers applies weight methodology. The set of server may alter the model by applying user input data.

In some embodiments, the set of servers store data with one or more storage servers in one or more data centers (e.g., mainframe). The user can also review the (e.g., encrypted) data from the set of servers on the user's mobile device. In some embodiments, the user can access the encrypted data using an issued ID card from a security system or office.

It is to be understood that the system 1500 is an example system and different embodiments may use the different resolution captured data differently. For instance, in the example system 1500, the server computer performs various tasks, including creating 3D models and performing facial or person identification. In some embolisms, such operations are not performed on server computers but on client devices. Also, severer tasks that are shown as being performed by one device or one server can potentially be distributed amongst servers in a server cloud.

### IV. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Computer System

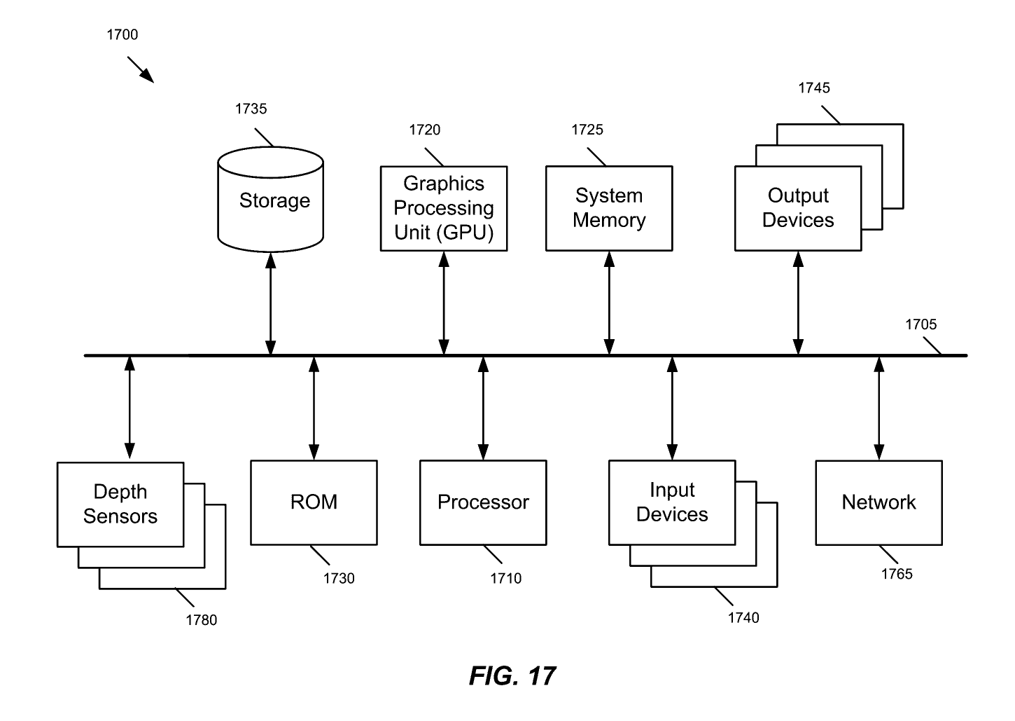

In some embodiment, one or more of the system's programs operate on a computer system. FIG. 17 conceptually illustrates an electronic system 1700 with which some embodiments of the invention are implemented. The electronic system 1700 may be a computer (e.g., a desktop computer, personal computer, tablet computer, etc.), server, dedicated switch, phone, PDA, or any other sort of electronic or computing device. Such an electronic system includes various types of computer readable media and interfaces for various other types of computer readable media. Electronic system 1700 includes a bus 1705, processing unit(s) 1710, a system memory 1725, a read-only memory 1730, a permanent storage device 1735, input devices 1740, and output devices 1745.

The bus 1705 collectively represents all system, peripheral, and chipset buses that communicatively connect the numerous internal devices of the electronic system 1700. For instance, the bus 1705 communicatively connects the processing unit(s) 1710 with the read-only memory 1730, the system memory 1725, and the permanent storage device 1735.

From these various memory units, the processing unit(s) 1710 retrieves instructions to execute and data to process in order to execute the processes of the invention. The processing unit(s) may be a single processor or a multi-core processor in different embodiments.

The read-only-memory (ROM) 1730 stores static data and instructions that are needed by the processing unit(s) 1710 and other modules of the electronic system. The permanent storage device 1735, on the other hand, is a read-and-write memory device. This device is a non-volatile memory unit that stores instructions and data even when the electronic system 1700 is off. Some embodiments of the invention use a mass-storage device (such as a magnetic or optical disk and its corresponding disk drive) as the permanent storage device 1735.

Other embodiments use a removable storage device (such as a floppy disk, flash memory device, etc., and its corresponding drive) as the permanent storage device. Like the permanent storage device 1735, the system memory 1725 is a read-and-write memory device. However, unlike storage device 1735, the system memory 1725 is a volatile read-and-write memory, such a random access memory. The system memory 1725 stores some of the instructions and data that the processor needs at runtime. In some embodiments, the invention's processes are stored in the system memory 1725, the permanent storage device 1735, and/or the read-only memory 1730. From these various memory units, the processing unit(s) 1710 retrieves instructions to execute and data to process in order to execute the processes of some embodiments.

The computing device also communicates with a set of one or more depth sensors 1780. In FIG. 17, the bus 1705 connects to the depth sensors. As stated above, the method of some embodiments uses a single or array of depth sensors that work like a telescope to scan different ranges.

The bus 1705 also connects to the input and output devices 1740 and 1745. The input devices 1740 enable the user to communicate information and select commands to the electronic system. The input devices 1740 include alphanumeric keyboards and pointing devices (also called “cursor control devices”), cameras (e.g., webcams), microphones or similar devices for receiving voice commands, etc. The output devices 1745 display images generated by the electronic system or otherwise output data. The output devices 1745 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 17, bus 1705 also couples electronic system 1700 to a network 1765 through a network adapter (not shown). In this manner, the computer can be a part of a network of computers (such as a local area network (“LAN”), a wide area network (“WAN”), or an Intranet, or a network of networks, such as the Internet. Any or all components of electronic system 1700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

B. Mobile Device

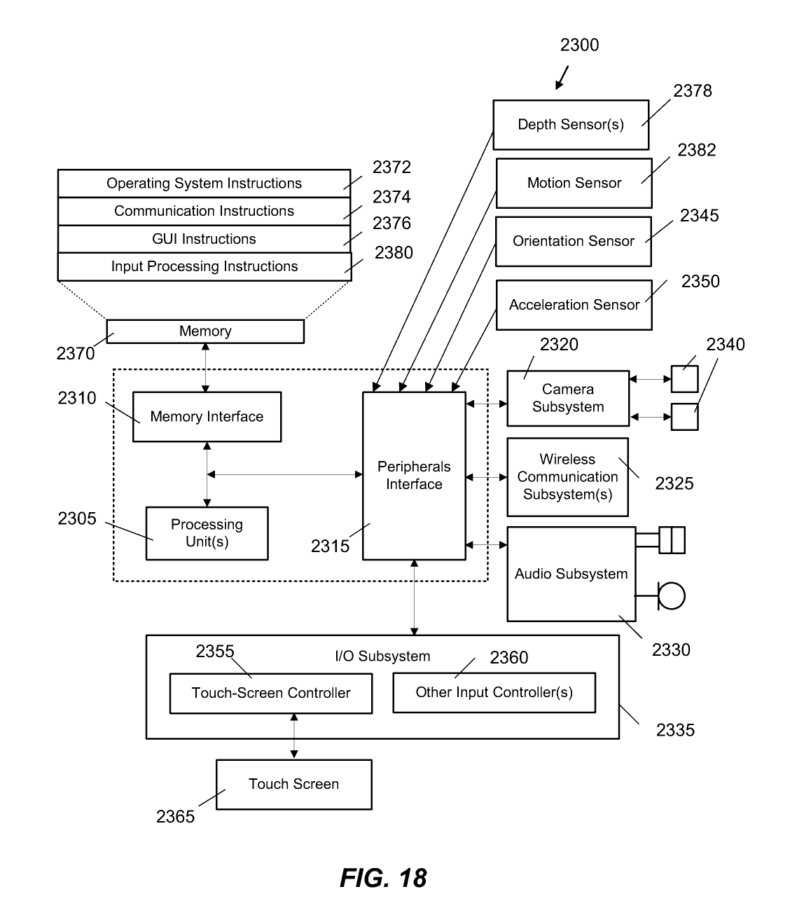

In some embodiment, one or more of the system's programs operate on a mobile device. FIG. 18 shows an example of an architecture 1800 of such a mobile computing device. Examples of mobile computing devices include smart phones, tablets, laptops, etc. The mobile computing device is also a capturing device, in some embodiments. As shown, the mobile computing device 1800 includes one or more processing units 1805, a memory interface 1810 and a peripherals interface 1815.

The peripherals interface 1815 is coupled to various sensors and subsystems, including a camera subsystem 1820, a wireless communication subsystem(s) 1825, an audio subsystem 1830, an I/O subsystem 1835, etc. The peripherals interface 1815 enables communication between the processing units 1805 and various peripherals.

In some embodiments, the mobile device has a set of one or more depth sensors 1878. For instance, in FIG. 18, the set of depth sensors 1878 is coupled to the peripherals interface 1815 to facilitate depth capturing operations. As stated above, the method of some embodiments uses a single or array of depth sensors that work like a telescope to scan different ranges.

The set of depth sensors 1878 may be used with the camera subsystem 1820 to capture 3D data (e.g., distance data). Also, for instance, the motion sensor 1882 is coupled to the peripherals interface 1815 to facilitate motion sensing operations. Further, for instance, an orientation sensor 1845 (e.g., a gyroscope) and an acceleration sensor 1850 (e.g., an accelerometer) is coupled to the peripherals interface 1815 to facilitate orientation and acceleration functions.

The camera subsystem 1820 is coupled to one or more optical sensors 1840 (e.g., a charged coupled device (CCD) optical sensor, a complementary metal-oxide-semiconductor (CMOS) optical sensor, etc.). The camera subsystem 1820 coupled with the optical sensors 1840 facilitates camera functions, such as image and/or video data capturing. As indicated above, the camera subsystem 1820 may work in conjunction with the depth sensor 1878 to capture 1878 to capture 3D data. The camera subsystem 1820 may be used with some other sensor(s) (e.g., with the motion sensor 1882) to estimate depth.

The wireless communication subsystem 1825 serves to facilitate communication functions. In some embodiments, the wireless communication subsystem 1825 includes radio frequency receivers and transmitters, and optical receivers and transmitters (not shown in FIG. 18). These receivers and transmitters are implemented to operate over one or more communication networks such as a LTE network, a Wi-Fi network, a Bluetooth network, etc. The audio subsystem 1830 is coupled to a speaker to output audio (e.g., to output different sound effects associated with different image operations). Additionally, the audio subsystem 1830 is coupled to a microphone to facilitate voice-enabled functions, such as voice recognition, digital recording, etc.

The I/O subsystem 1835 involves the transfer between input/output peripheral devices, such as a display, a touch screen, etc., and the data bus of the processing units 1805 through the peripherals interface 1815. The I/O subsystem 1835 includes a touch-screen controller 1855 and other input controllers 1860 to facilitate the transfer between input/output peripheral devices and the data bus of the processing units 1805. As shown, the touch-screen controller 1855 is coupled to a touch screen 1865. The touch-screen controller 1855 detects contact and movement on the touch screen 1865 using any of multiple touch sensitivity technologies. The other input controllers 1860 are coupled to other input/control devices, such as one or more buttons. Some embodiments include a near-touch sensitive screen and a corresponding controller that can detect near-touch interactions instead of or in addition to touch interactions.

The memory interface 1810 is coupled to memory 1870. In some embodiments, the memory 1870 includes volatile memory (e.g., high-speed random access memory), non-volatile memory (e.g., flash memory), a combination of volatile and non-volatile memory, and/or any other type of memory. As illustrated in FIG. 18, the memory 1870 stores an operating system (OS) 1872. The OS 1872 includes instructions for handling basic system services and for performing hardware dependent tasks.

The memory 1870 may include communication instructions 1874 to facilitate communicating with one or more additional devices; graphical user interface instructions 1876 to facilitate graphic user interface processing; input processing instructions 1880 to facilitate input-related (e.g., touch input) processes and functions. The instructions described above are merely exemplary and the memory 1870 includes additional and/or other instructions in some embodiments. For instance, the memory for a smart phone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 18 are shown as separate components, it is to be understood that two or more components may be integrated into one or more integrated circuits. In addition, two or more components may be coupled together by one or more communication buses or signal lines. Also, while many of the functions have been described as being performed by one component, it is to be understood that the functions described with respect to FIG. 18 may be split into two or more integrated circuits.

While the invention has been described with reference to numerous specific details, it is to be understood that the invention can be embodied in other specific forms without departing from the spirit of the invention. In addition, a number of the figures (including FIGS. 3 and 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, it is to be understood that the invention is not to be limited by the foregoing illustrative details, but rather is to be defined by the appended claims.

What is claimed is:

1. A method of capturing data with a computing device that is associated with a set of one or more depth sensors, the method comprising:
with the set of depth sensors:
in a far distance, capturing a low resolution depth map of an object in a scene;
in a close distance, capturing a high resolution depth map of the object in the scene; and
storing the low and high resolution depth maps.

2. The method of claim 1 further comprising producing a 3D model of the object in the scene using the low and high resolution depth maps.

3. The method of claim 1, wherein the computing device is a first computing device, the method further comprising sending data, which are based on the low and high resolution depth maps, over a network to a second computing device.

4. The method of claim 3 further comprising compressing the low and high resolution depth maps prior to sending the maps.

5. The method of claim 1 further comprising:
deriving data values based on the low and high resolution depth maps; and
searching a data store to identity the object from a number of different objects using the data values.

6. The method of claim 1 further comprising:
with the set of depth sensors:
in a mid distance, capturing a mid resolution depth map of the object in the scene.

7. The method of claim 1 further comprising:
receiving the computing device's user's input to capture data relating the object; and
providing instructions to the set of depth sensors to rapidly or simultaneously capture the low and high resolution depth maps in succession starting with the far distance and then proceeding to the close distance.

8. The method of claim 1 further comprising:
receiving the computing device's user's input to capture data relating the object; and
providing instructions to the set of depth sensors to rapidly or simultaneously capture the low and high resolution depth maps in succession starting with the close distance and then proceeding to the far distance.

9. The method of claim 1 further comprising tracking, at each particular distance, a current position and a captured target surface area of the object in order to reconstruct the object with low and high resolution depth data.

10. The method of claim 9, wherein the high resolution depth data is used to provide a high resolution detailed view of a selected area of the object.

11. The method of claim 1 further comprising dynamically changing the depth sensor range of the set of depth sensors from far distance to close distance when capturing the low and high resolution depth maps.

12. The method of claim 1 further comprising dynamically changing the depth sensor range of the set of depth sensors from close distance to far distance when capturing the high and low resolution depth maps.

13. The method of claim 1, wherein the set of sensors has only one sensor that changes to different distance ranges when capturing the low and high resolution depth maps relating to the object.

14. The method of claim 1, wherein the set of sensors has more than one sensor that is tuned or set to scan with different distance ranges.

15. The method of claim 1, wherein the set of sensors captures the low and high resolution depth maps from a single perspective.

16. The method of claim 1, wherein the computing device is associated with a set of cameras, the method further comprising:
with the set of depth sensors:
in the far distance, capturing, along with the low resolution depth map, a first photo showing the object in the scene.
in the close distance, capturing, along with the high resolution depth map, a second photo that shows a close-up of the object shown in the first photo.

17. The method of claim 1, wherein the computing device is a tablet, smart phone, gaming system, stationary computer, or portable computer.

18. A computing device comprising:
a plurality of depth sensors with different distances or zoom lens to capture depth data relating a same target object with different resolutions;
a set of processing units to process the captured depth data;
a set of storages to store the captured depth data.

19. The computing device of claim 18, wherein the plurality of sensors simultaneously captures the same target of object with different resolutions.

20. A non-transitory machine readable medium storing a program for execution by at least one processing unit, the program comprising sets of instructions for:
receiving different resolution depth data sets relating to a target object; and
generating a 3D model of the object by:
building the 3D model with different resolution of details on different areas based on the different resolution depth data sets.
